(19) United States
(12) Patent Application Publication
(10) Pub. No.: US 2008/0166966 A1
(43) Pub. Date: Jul. 10, 2008

(54) Wireless Communication Apparatus and Communication Control Method

(76) Inventors: Shogo Hamasaki, Osaka (JP); Kenji Hisatomi, Osaka (JP); Michiaki Matsuo, Tokyo (JP); Kenji Takagi, Kanagawa (JP); Atsushi Saso, Kanagawa (JP); Mizuho Sakakibara, Tokyo (JP)

Correspondence Address: WENDEROTH, LIND & PONACK L.L.P., 2033 K. STREET, NW, SUITE 800, WASHINGTON, DC, 20006, US

(21) Appl. No.: 11/793,233

(22) PCT Filed: Dec. 20, 2005
(86) PCT No.: PCT/JP2005/023321

§ 371 Date: Jun. 15, 2007

(30) Foreign Application Priority Data
Dec. 20, 2004 (JP) 2004-367162

(51) Int. Cl. H04B 7/00

(52) U.S. Cl. 455/41.2

(57) ABSTRACT

A wireless communication apparatus for performing wireless communication with another communication apparatus comprises: a contact sensor 101 operable to detect physical contact with the another communication apparatus; a short-range communication unit 102 operable to transmit management information required for a session of the wireless communication to the another communication apparatus, using a short-range communication method different from a method of the wireless communication; and a control unit 106 operable to cause the short-range communication unit 102 to transmit the management information in response to a detection of the physical contact by the contact sensor 101, and start the session with the another communication apparatus after the management information is transmitted.

### TECHNICAL FIELD

The present invention relates to a technology for data transmission and reception between terminals using wireless communications, in particular to getting management information necessary to establish a session between the terminals to be stored in each terminal.

### BACKGROUND ART

Although wireless communications, such as wireless LANs, are convenient, there is a risk of data leakage due to interception of radio waves. Especially, leakage of management information necessary to establish a wireless communication path and carry out a session—such as a device address of an apparatus with which communication is to be made (hereinafter referred to as the “communication partner apparatus”), a net mask, a gateway address, an authentication key, and an encryption key-presents a serious risk to the safety of wireless communications. Given this factor, it is possible to beef up the safety of wireless communications by manually entering management information of communication partner terminals into each terminal.

Such manual entry of the management information into each terminal is useful in the situation where communication partner terminals are specified ones, for example, used in a house; however, in the situation where communication needs to be frequently made with new terminals, it is troublesome to enter the management information every time to make communication with a new terminal.

For example, information apparatuses including digital cameras, PDAs (Personal Digital Assistants) and personal computers, have been widely disseminated recent years, and many users carry around with them on a regular basis. In particular, recording media mounted on such information apparatuses have increased their capacities. Accordingly, one well-accepted usage of the information apparatuses is that large amounts of captured image data are recorded on recording media, and then the users look at each other's images at an outside location and exchange image data between their apparatuses. For such data exchange between apparatuses in outside environments, wireless LANs and other wireless communications requiring no cables are convenient; however, it is quite cumbersome to manually enter the management information each time the user wants to exchange data with another user that he/she meets in an outside environment.

Given this factor, one suggested method is to exchange the management information before establishment of a communication path by using a transmit power smaller than a transmit power of a radio wave used for wireless communication after the communication path is established (e.g. Patent Reference 1).

<Patent Reference 1>

Japanese Laid-Open Patent Application No. 2000-295658

### DISCLOSURE OF THE INVENTION

### Problems that the Invention is to Solve

For the following reasons, however, there are issues of safety associated with the exchange of the management information using a transmit power smaller than a transmit power of a radio wave used for wireless communication after establishment of the communication path.

At the time when the exchange of the management information between terminals is made, only one of the terminals first comes into a state of transmitting or receiving the management information. In this condition, it is possible for a third person's terminal to readily disguise itself as a legitimate communication partner terminal. In addition, if the transmit power is small, the effect of noises can be significant, which may cause an increase in the number of retries following communication failures. An increase in the number of retries results in an increase in the communication period, which in turn increases the chances of the management information being illegally intercepted by ill-intentioned third parties. As a result, the management information is leaked, damaging the safety of wireless communications.

The present invention aims at offering a wireless communication apparatus capable of safely exchanging the management information with a communication partner apparatus using a simple procedure.

### Means to Solve the Problem

In order to accomplish the above object, the present invention is a wireless communication apparatus for performing wireless communication with another communication apparatus and comprises: a detection unit operable to detect physical contact with the another communication apparatus; a transmission unit operable to transmit 1^{st} management information required for a session of the wireless communication to the another communication apparatus; using a short-range communication method different from a method of the wireless communication; and a communication control unit operable to cause the transmission unit to transmit the 1^{st} management information in response to a detection of the physical contact, and start the session with the another communication apparatus after the 1^{st} management information is transmitted.

### ADVANTAGEOUS EFFECTS OF THE INVENTION

If apparatuses are distant from each other, radio waves transmitted from one of the apparatuses reaching to the other are generally weak and accordingly the effect of noises is significant; however, the wireless communication apparatus of the present invention transmits the management information in response to a detection of contact between the terminals according to the structure described in the Means to Solve the Problem above. Accordingly, the management information will not be transmitted indiscriminatingly when the apparatuses are located away from each other, whereby minimizing the effect of noises.

Additionally, when communication is made between the wireless communication apparatuses of the present invention, both apparatuses use their contact as a trigger for starting the communication. As a result, operations of the transmission and reception sides are made in synchronization with each other, and therefore the time period during which only one of the apparatuses is set, ahead of the other apparatus, in a state of transmitting/receiving the management information can be reduced to be extremely short. Furthermore, because timings of the transmission and reception are set in synchronization, the transmission and reception of the management information can be completed in a short period of time. Thus, the shortened communication period significantly lowers the possibility of the management information being intercepted by third parties, as well as the chances of receiving false management information from a different apparatus “masquerading” as a legitimate communication apparatus.

Another advantageous effect obtained by being able to complete the transmission and reception of the management information in a short period of time is that the electric power consumption of the wireless communication apparatus can be reduced.

In addition, the wireless communication apparatus of the present invention may further comprise a reception unit operable to, using the short-range communication method, receive 2^{nd} management information transmitted by the another communication apparatus. Here, the communication control unit causes the reception unit to receive the 2^{nd} management information in response to the detection of the physical contact, and performs the session based on the received 2^{nd} management information.

Herewith, since the reception process is started in response to the contact, the present invention is free from constantly monitoring unpredictably transmitted radio waves from the transmitting apparatus, which is the case of conventional technologies. This leads to a further pronounced effect of lowering the electric power consumption.

In addition, the short-range communication method used by the transmission unit to transmit the 1^{st} management information may use a radio wave whose transmit power is smaller than a transmit power of a radio wave used for the wireless communication. Alternatively, the short-range communication method may be a communication method for transmitting and receiving a signal to and from the another communication apparatus through a signal path via a point of the physical contact.

These structures make it more difficult for third parties to intercept the management information, thereby ensuring further secure communications.

In addition, the detection unit may detect the physical contact in a case where a contact detecting portion of the another communication apparatus comes in contact with a contact detecting portion of the wireless communication apparatus.

This structure prevents the wireless communication apparatus from transmitting its management information when the contact detecting portion is brought in contact with a part of the communication partner apparatus other than the contact detecting portion thereof and therefore the communication partner apparatus does not transmit and receive the management information. Accordingly, unnecessary transmission of the management information is avoided, which results in a further reduction in the chances of the management information being intercepted by third parties.

### BRIEF DESCRIPTION OF THE DRAWINGS

FIG. 1 shows a usage embodiment of a wireless communication apparatus of the present invention;

FIG. 2 schematically shows a state in which a mobile terminal 10 and an image capturing apparatus 20 are brought in contact with each other;

FIG. 3 shows internal structures of the mobile terminal 10 and the image capturing apparatus 20 according to Embodiment 1;

FIG. 4 schematically shows a structure of a contact sensor 101;

FIG. 5 shows a function list provided by the image capturing apparatus 20;

FIG. 6 shows an outline of operations performed by an image capturing system 1 according to Embodiment 1;

FIG. 7 is a flowchart showing a procedure of a communication establishment process;

FIG. 8 is a flowchart showing a procedure of an image capturing process;

FIG. 9 shows an image capturing system including two mobile terminals;

FIG. 10 shows an operational principle of contact detection according to a modification;

FIG. 11 schematically shows the contact sensor 101 according to another modification;

FIG. 12 shows an image capturing system 2 according to Embodiment 2;

FIG. 13 shows an internal structure of a mobile terminal 10a according to Embodiment 2;

FIG. 14 shows a terminal list stored by a list storage unit 105 of the mobile terminal 10a after establishment of a network;

FIG. 15 shows an outline of operations performed by the image capturing system 2;

FIG. 16 shows a terminal list stored by list storage units 105 of mobile terminals 10b and 10c after establishment of a network;

FIG. 17 is a flowchart showing a procedure of the communication establishment process according to Embodiment 2;

FIG. 18 is a function list stored by the list storage unit 105 of the mobile terminal 10a after establishment of a network;

FIG. 19 shows a function list stored by the list storage units 105 of the mobile terminals 10b and 10c after establishment of a network;

FIG. 20 is a flowchart showing a procedure of an image capturing process performed when an image is captured by a main terminal according to Embodiment 2;

FIG. 21 is a flowchart showing a procedure of a transmission process in which transmission is performed by the main terminal;

FIG. 22 is a flowchart showing a procedure of the image capturing process performed when an image is captured by a slave terminal according to Embodiment 2;

FIG. 23 shows an information processing system 3 according to Embodiment 3;

FIG. 24 shows internal structures of apparatuses making up the information processing system 3 according to Embodiment 3;

FIG. 25 shows an outline of a data exchanging process according to Embodiment 3;

FIG. 26 schematically shows an operational state of the data exchange process; and

FIG. 27 is a flowchart showing a control procedure of the data exchange process performed by a control unit 301.

### EXPLANATION OF REFERENCES

1, 2 image capturing system
3 information processing system
10, 10a-10c, 30a-30d mobile terminal
11, 21 contact detecting unit
12 operation input unit
13 screen
14, 23 antenna
15, 22 camera
20 image capturing apparatus
20a operation unit
20b camera unit
30 wall
90 wireless network
101, 201 contact sensor
102, 202 short-range communication unit
103, 203 wireless communication unit
104 data accumulation unit
105 list storage unit
106, 206, 301 control unit
150 case
151 electrode
152 nonconductive element
153 spring
154 conductor
155 concave portion
156 convex portion
204 storage unit
205 deletion unit

### BEST MODE FOR CARRYING OUT THE INVENTION

### Embodiment 1

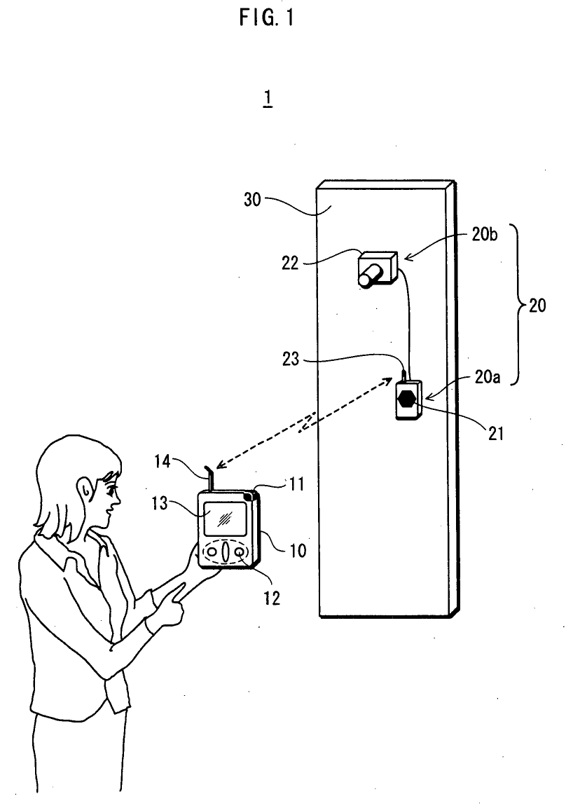

The following describes embodiments of wireless communication apparatuses according to the present invention. First, a usage application is described in relation to the implementation of the wireless communication apparatuses of the present invention. FIG. 1 shows the usage embodiment of the wireless communication apparatuses of the present invention. In FIG. 1, the wireless communication apparatuses of the present invention are a mobile terminal 10 and an image capturing apparatus 20, which form an image capturing system 1.

As to the image capturing system 1, the mobile terminal 10 is held in hand of the user who is a tourist while the image capturing apparatus 20 is installed in a tourist site, at an imaging spot with good scenery. The image capturing system 1 is used by the user for taking a commemorative photo of the user himself/herself in the scenery at the imaging spot using the image capturing apparatus 20.

The mobile terminal 10 is a PDA having a wireless LAN communication function, and has a contact detecting portion 11, an operation input unit 12 which includes operation buttons and the like, a screen 13, and an antenna 14 on the outer surface.

The image capturing apparatus 20 is a network camera having a wireless LAN communication function, and is fixed on wall 30 positioned in the tourist site, at the imaging spot with good scenery. The image capturing apparatus 20 has a structure in which an operation unit 20a and a camera unit 20b are connected in a manner to be able to establish electrical communication. The camera unit 20b having a camera 22 is installed at a high point which the user with the mobile terminal 10 cannot reach; on the other hand, the operation unit 20a having a contact detecting portion 21 and an antenna 23 is disposed at a position where the user can reach.

The mobile terminal 10 and the image capturing apparatus 20 are able to establish a wireless LAN session by exchanging each other's management information including a device address, a net mask, a gateway address, an authentication key, and an encryption key. Accordingly, the user can send instructions from the mobile terminal 10 to the image capturing apparatus 20 to execute functions such as pan, tilt, zoom and shoot, and receive captured image data.

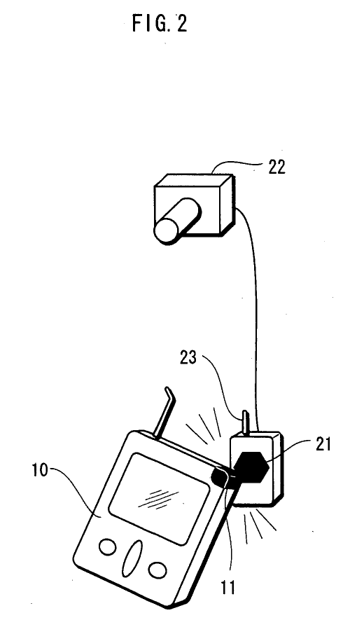

The image capturing system 1 of FIG. 1 is characterized in that when the mobile terminal 10 is moved close to the operation unit 20a of the image capturing apparatus 20 and then the contact detecting portion 11 of the mobile terminal 10 is physically brought in contact with the contact detecting portion 21 of the image capturing apparatus 20, as shown in FIG. 2, the mobile terminal 10 and image capturing apparatus 20 transmit and receive their management information to and from each other at a transmit power smaller than a transmit power of a radio wave used for wireless LAN data communication, and subsequently start a normal wireless LAN session.

With the image capturing system 1, the user holding the mobile terminal 10 in hand stands in front of the image capturing apparatus 20 and remotely controls the image capturing apparatus 20. In this way, it is possible to obtain image data taken from a high and scenic point, which is unlikely to be captured with handheld shooting.

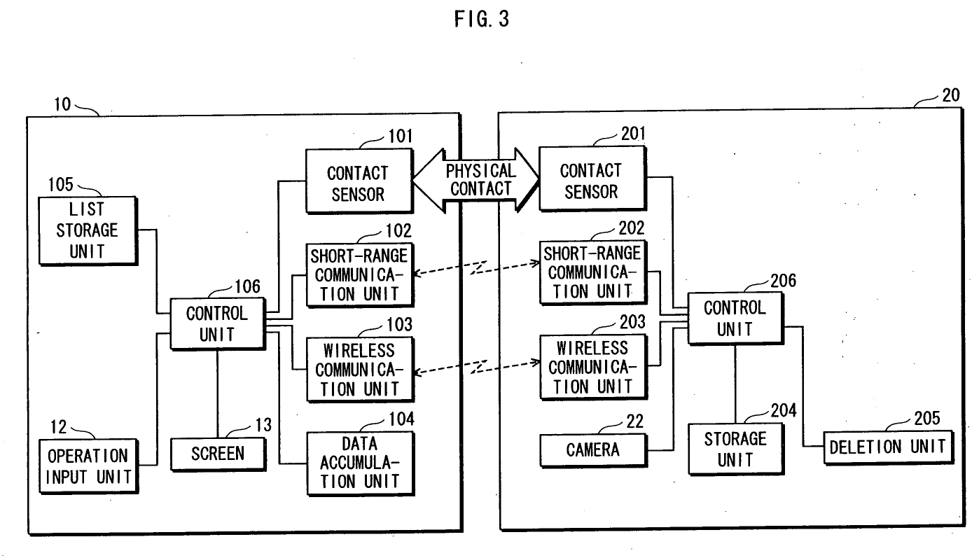

The following describes the internal structure of each apparatus of the present invention. FIG. 3 shows internal structures of the mobile terminal 10 and the image capturing apparatus 20 according to Embodiment 1.

The mobile terminal 10 is first explained. As shown in the figure, the mobile terminal 10 includes: an operation input unit 12; a screen 13; a contact sensor 101; a short-range communication unit 102; a wireless communication unit 103; a data accumulation unit 104; a list storage unit 105; and a control unit 106.

The operation input unit 12 is an operation input device provided on the PDA, and includes ten keys and other direct keys, a touch panel, a joystick, and a sliding lever. The operation input unit 12 receives user operations such as a press of the shutter button.

The screen 13 is a display device such as an LCD or an organic EL, and displays images.

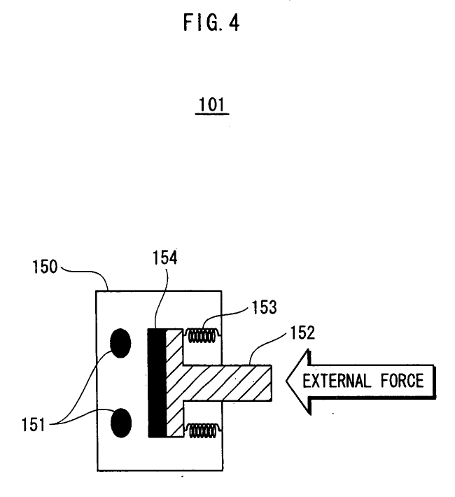

The contact sensor 101 has a function to detect physical contact made at the contact detecting portion 11 as an electric signal, and transmits a detection signal to the control unit 106 when contact is detected. Specifically speaking, the contact sensor 101 is, as shown in FIG. 4, a push switch including: two electrodes 151 fixed in a case 150; nonconductive element 152 made of a resin and formed so as to be movable by an external force in the right and left directions of the figure; a conductor 154 fixed by the nonconductive element 152; and springs 153 connecting the element 152 and the case 150. When no external force is applied, the nonconductive element 152 is held at a position where the electrodes 151 and the conductor 154 are electrically cut off by the springs 153. As an external force in the left direction of FIG. 4 is applied to the nonconductive element 152, the nonconductive element 152 is gradually pushed in and eventually the electrodes 151 and the conductor 154 come into contact with each other. On the other hand, when the external force is removed, the springs 153 return to their uncompressed state by their own elastic force to thereby push back the nonconductive element 152 to the original position, resulting in that the two electrodes 151 are electrically cut off. Accordingly, by monitoring the electric conducting state between the two electrodes 151, the contact sensor 101 is capable of electrically detecting physical contact. Note that the strength of the external force required to detect contact can be fixed by adjusting the spring coefficient of the springs 153. For example, setting a larger spring coefficient avoids detecting light contact (weak external force) while allowing only contact exceeding a certain magnitude (strong external force) to be detected. Thereby, it is possible to prevent the mobile terminal 10 from operating improperly as the contact detecting portion 11 comes in contact with some object by an erroneous operation. Thus, the use of the push switch shown in FIG. 4 provides a contact sensor whose detection sensitivity to contacts can be freely adjusted.

The short-range communication unit 102 of FIG. 3 has a function to transmit and receive data at a power smaller than a transmit power of a radio wave used by the wireless LAN, and is used to transmit management information of the mobile terminal 10 and receive management information transmitted from a different apparatus. Here, the magnitude of the transmit power needs only to be the minimum necessary to allow the transmitted radio waves to reach the image capturing apparatus 20 in the condition where the mobile terminal 10 and the image capturing apparatus 20 are in proximity to each other immediately after being brought in contact.

The wireless communication unit 103 is a publicly known wireless communication means that transmits and receives data to and from other apparatuses by a wireless LAN, and is used to transmit and receive image data, control data and the like. Note that the short-range communication unit 102 and wireless communication unit 103 may be realized with discrete pieces of hardware. Alternatively, a single transmission and receiving unit may be provided to realize both functions of the short-range communication unit 102 and the wireless communication unit 103 by switching the transmit power between low and high.

The data accumulation unit 104 is a nonvolatile storage, such as a flash memory or a hard disk drive, and is used to record thereon image data.

The list storage unit 105 is a volatile memory, such as a DRAM, and is used to store therein a function list, which is a list of services that can be offered by the image capturing apparatuses 20.

The control unit 106 is a typical computer system including a CPU, and a ROM storing therein programs and a RAM. The control unit 106 causes a program stored in the ROM to be read to the CPU, and then makes the program and hardware resources operate in cooperation, whereby realizing controls of a communication establishment process and an image capturing process.

The communication establishment process of the control unit 106 is a process where in response to a contact detection of the contact sensor 101, the control unit 106 causes the short-range communication unit 102 to transmit and receive the management information to and from a communication partner apparatus of the mobile terminal 10, and after the acquisition of the management information, the control unit 106 causes the wireless communication unit 103 to establish a wireless LAN connection with the image capturing apparatus 20.

The image capturing process of the control unit 106 is a process of acquiring a captured image by receiving image data from the image capturing apparatus 20. The reception of the image data is realized by transmitting a request for control of the camera 22 to the image capturing apparatus 20 during a wireless LAN session with the image capturing apparatus 20, which has been started by the communication establishment process, and thereby remotely operating the image capturing apparatus 20.

The following explains the image capturing apparatus 20. The image capturing apparatus 20 includes the camera 22, a contact sensor 201, a short-range communication unit 202, a wireless communication unit 203, a storage unit 204, a deletion unit 205, and a control unit 206.

The camera 22 is a digital camera using a CCD or a CMOS sensor.

The contact sensor 201, the closer-range communication unit 202 and the wireless communication unit 203 have the same structures as the contact sensor 101, the short-range communication unit 102 and the wireless communication unit 103, respectively, of the mobile terminal 10.

The storage unit 204 is a volatile or nonvolatile buffer memory that can temporarily store therein movies and still images taken by the camera 22.

The deletion unit 205 has a function to delete image data stored in the storage unit 204.

The control unit 206 has the same structure as the control unit 106 of the mobile terminal 10. The control unit 206 causes a program stored in the ROM to be read to the CPU, and then makes the program and hardware resources operate in cooperation, whereby realizing controls of a communication establishment process and an image capturing process.

The communication establishment process of the control unit 206 is the same process as the communication establishment process of the control unit 106. The image capturing process of the control unit 206 is a process where: in a wireless LAN session, the control unit 206 receives a request for control of the camera 22 from the mobile terminal 10; operates the camera 22 according to the request; transmits, to the mobile terminal 10, an image for confirmation (hereinafter, the “preview image”) captured by the camera 22 or an image taken when a request to press the shutter button is received (the “shuttered image”); and causes, after the transmission of the shuttered image, the deletion unit 205 to delete image data stored in the storage unit 204 prior to the end of the session. Here, the deletion of a preview image and a shuttered image prevents these images that contain the user from being released to others, which leads to protecting the user's privacy, such as the rights of portrait.

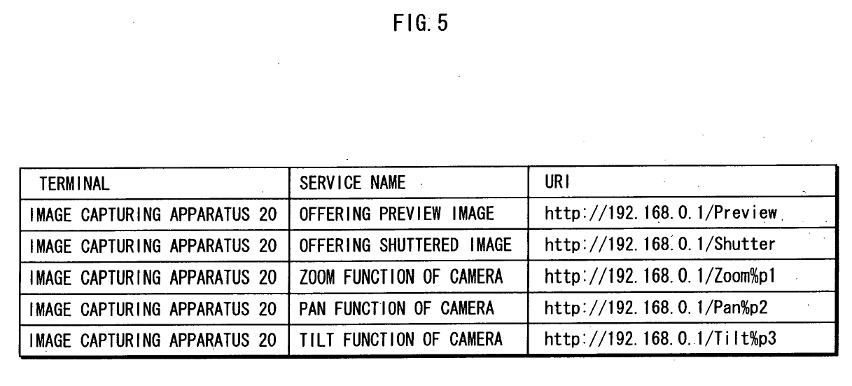

Note that the present embodiment uses URIs (Universal Resource Identifiers) as a scheme for addressing service objects offered on the network. The mobile terminal 10 and the image capturing apparatus 20 respectively have, as a function list, a table showing the correspondence between services that can be offered and their URIs. The mobile terminal 10 and the image capturing apparatus 20 are able to clearly specify services that each of them offers by providing its function list to a communication partner apparatus. FIG. 5 shows a function list of the image capturing apparatus 20. There is a function list for each terminal, and such a function list is composed of multiple records. Each record is made up of three fields: a terminal name; a service name; and a URI. The terminal name indicates the name of the terminal. The service name indicates the name of a function that can be provided by the terminal. The URI indicates a service object expressed as a HTTP (Hypertext Transfer Protocol) string, and generally includes an address of the terminal on the network. In the example of FIG. 5, 192.168.0.1 in the URIs is the address of the image capturing apparatus 20 on the network. Parameters, such as a camera zoom magnification p1, can be included in a URI, placed after a sign character of “%”.

Specifically speaking, when a wireless LAN connection is established in the communication establishment process, a function list setting forth various services related to image capturing is passed out from the image capturing apparatus 20 to the mobile terminal 10. Consequently in the image capturing process, on the mobile terminal 10 side, the control unit 106 converts a user's request input with the operation input unit 12 into a URI of a corresponding service by referring to the function list, and then requests the image capturing apparatus 20 for the service via the network. On the image capturing apparatus 20 side, in the image capturing process, image data or the like that is a service to be provided in response to the request is transmitted to the mobile terminal 10.

Thus have been described the internal structures of the mobile terminal 10 and image capturing apparatus 20 of the present embodiment. As to the image capturing system 1 comprising the mobile terminal 10 and the image capturing apparatus 20 having such structures, when the contact detecting portion 11 of the mobile terminal 10 comes in physical contact with the contact detecting portion 21 of the image capturing apparatus 20 as shown in FIG. 2, the contact is detected by both apparatuses substantially at the same time. In response to the detection, both control units 106 and 206 instruct the short-range communication units 102 and 202, respectively, to transmit the management information of its own apparatus and receive the management information of the other apparatus. Accordingly, even if another mobile terminal is in proximity, each of the mobile terminal 10 and the image capturing apparatus 20 is able to obtain the other's address.

Note that, in the case where multiple image capturing apparatuses are installed in proximity to the mobile terminal 10, UPnP (Universal Plug and Play) can be applied as a method of identifying one image capturing apparatus with which the mobile terminal 10 is going to make data communication (hereinafter, the “data-communication partner apparatus”). Specifically speaking, in response to contact between each other's contact sensors 101 and 201, the image capturing apparatus 20 notifies its UUID (Universal Unique Identifier) to the mobile terminal 10. This notification can be achieved by including the UUID in the management information of the image capturing apparatus 20 as UPnP-device finding information and transmitting the resultant management information from the short-range communication unit 202 of the image capturing apparatus 20 to the short-range communication unit 102 of the mobile terminal 10. Next, using the wireless communication unit 103, the mobile terminal 10 multicasts a device search request (M-Search) with the use of the UUID of the image capturing apparatus 20 as a key. In response to the device search request, the image capturing apparatus 20 notifies, using the wireless communication unit 203, a URI of its own device control information to the wireless communication unit 103 of the mobile terminal 10. Subsequently, the mobile terminal 10 obtains the device control information indicated by the URI using the wireless communication unit 103. Herewith, the mobile terminal 10 is able to find, from among two or more terminals, the image capturing apparatus 20, which is to be a data-communication partner apparatus, and perform control on it.

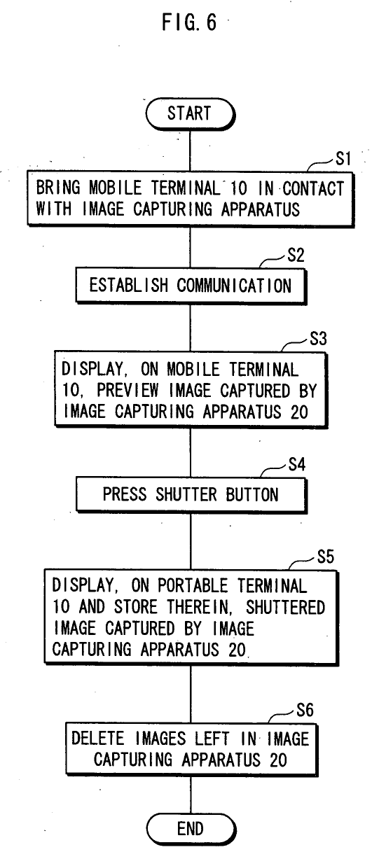

The following explains operations of the image capturing system 1 according to the present embodiment. FIG. 6 shows the outline of the operations performed by the image capturing system 1 according to Embodiment 1.

When the user brings the contact detecting portion 11 of the mobile terminal 10 in contact with the contact detecting portion 21 of the image capturing apparatus 20 (Step S1), the communication establish process is carried out between both apparatuses, and thereby wireless LAN communication is established (Step S2). Following the communication establishment, the image capturing process is carried out between the apparatuses, and a preview image is instantly displayed on the screen 13 of the mobile terminal 10 (Step S3). The user stands in front of the camera 22 with the mobile terminal 10 in hand, and instructs the camera 22 to execute functions, such as pan, tilt and zoon, using the operation input unit 12. After checking the screen 13 so as to obtain a photo with a desired composition, the user presses the shutter button (Step S4). At this moment, the shuttered image taken by the camera 22 is transmitted to the mobile terminal 10, and then recorded in the data accumulation unit 104 while being displayed on the screen 13 so as to allow the user to check the image (Step S5). Subsequently, at some point in time before the user ends the use of the image capturing system 1, the preview image and shuttered image are deleted from the image capturing apparatus 20 (Step S6).

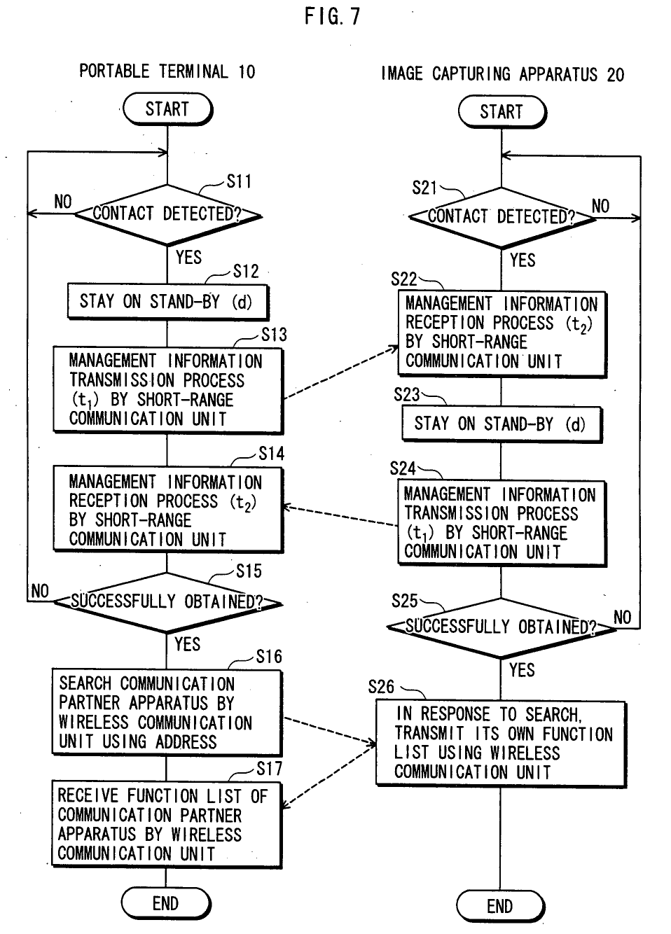

Next, as to the communication establishment process carried out in Steps S1 and S2 of FIG. 6, the procedure is detailed with reference to a flowchart. FIG. 7 is a flowchart showing the procedure of the communication establishment process. The process shown in the figure encompasses a procedure that starts with the exchange of the management information between the apparatuses, and then moves to the establishment of wireless LAN connection so as to create conditions allowing for acquisition of image data in accordance with user operations. Respective steps of the procedure are performed by the control unit 106 on the mobile terminal 10 side, and by the control unit 206 on the image capturing apparatus 20 side.

First, on the mobile terminal 10 side, the control unit 106 waits for a contact detection informed by the contact sensor 101 in the loop process of Step S11. On the image capturing apparatus 20 side, the control unit 206 waits for a contact detection informed by the contact sensor 201 in the loop process of Step S21.

When a contact detection is informed, the control unit 106 of the mobile terminal 10 stays on stand-by for a very short waiting time period d (Step S12), and subsequently instructs the short-range communication unit 102 to transmit its own management information only over a time period t1 (Step S13). On the other hand, the control unit 206 of the image capturing apparatus 20 instructs the short-range communication unit 202 to carry out a reception operation only for a predetermined minimum necessary time period t2 immediately after a contact detection is informed (Step S22). Here, the time period t2 is a sum of the waiting time period d and the time period t1, and the transmission and reception operations of both apparatuses are synchronized with each other.

Thus, the transmission of the management information is delayed by only the time period d so that the transmission process on the transmission side is started after the reception process has started on the reception side. This enables more reliable reception of the transmitted radio waves, realizing thereby secure communication.

Subsequently, the control unit 106 instructs the short-range communication unit 102 to carry out a reception operation only for the time period t2 (Step S14). On the other hand, the control unit 206 stays on stand-by for the very short waiting time period d (Step S23), and then instructs the short-range communication unit 202 to transmit its own management information only over the time period t1 (Step S24). Thus, with these processes to this point, the mobile terminal 10 and the image capturing apparatus 20 have completed the exchange of each other's addresses, which are used to identify these apparatuses on the network.

Note that in the case when the reception of the communication partner apparatus's address is unsuccessful due to poor wireless reception or the like (Step S15: No, Step S25: No), the control unit 106/206 returns to the loop process in Step S11/S21 and waits for a new contact detection.

In the subsequent processes after the exchange of each other's addresses, the communication between the mobile terminal 10 and the image capturing apparatus 20 is wireless LAN communication using the wireless communication units 103 and 203.

When the communication partner apparatus's address is normally and successfully received (Step S15: Yes, Step S25: Yes), on the mobile terminal 10 side, the control unit 106 causes the wireless communication unit 103 to search the image capturing apparatus 20 on the network (Step S16). On the image capturing apparatus 20 side, in response to the search, an instruction is presented to the wireless communication unit 203 to transmit, to the mobile terminal 10, a function list that can be provided (Step S26). The control unit 106 of the mobile terminal 10 receives the function list from the image capturing apparatus 20 and stores it in the list storage unit 105 (Step S17). According to these steps, a secure wireless communication path is established between the mobile terminal 10 and the image capturing apparatus 20, which enables bi-directional transmission and reception of control data and image data.

According to the above procedure, the transmission and reception of the management information is started in synchronization with each other in response to a detection of contact between the apparatuses, and therefore it is possible to make the time required to transmit management information, such as an address, short. That is, since the period for transmitting radio waves is short, it is possible to establish the communication between the mobile terminal 10 and the image capturing apparatus 20 in a reliable manner without wireless interference—even if a different mobile terminal and a different image capturing apparatus are brought in contact with each other and the communication establishment process is carried out around the time when the mobile terminal 10 and the image capturing apparatus 20 are transmitting and receiving the management information. In addition, it is possible to prevent such problems that a different apparatus “masquerades” as a legitimate communication apparatus and communications are intercepted under the direction of an ill-intentioned third person.

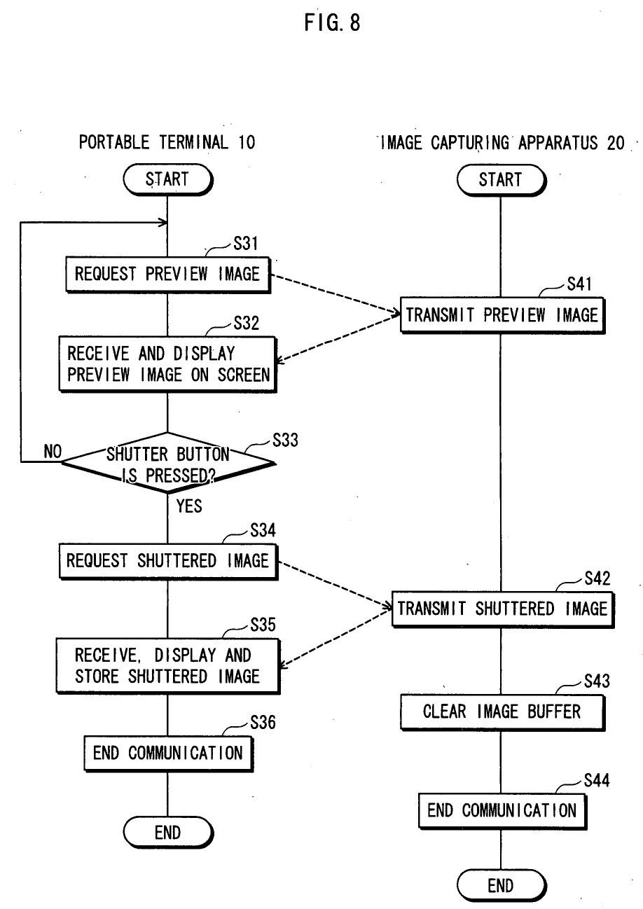

Next, as to the image capturing process carried out in Steps S3 to S6 of FIG. 6, the procedure is detailed with reference to a flowchart. FIG. 8 is a flowchart showing the procedure of the image capturing process. The image capturing process shown in the figure is performed by the control units 106 and 206 after the communication is established by the communication establishment process.

In the image capturing process, first, the control unit 106 of the mobile terminal 10 repeats the loop process of Steps S31 to S33. While updating preview images, the control unit 106 waits for the user to press the shutter button (hereinafter, the “shutter-button press operation”).

Specifically speaking, in the loop process of Steps S31 to S33, the control unit 106 takes out a URI requesting a preview image, http://192.168.0.1/Preview, from the function list stored in the list storage unit 105, and instructs the wireless communication unit 103 to transmit a preview request to the image capturing apparatus 20 via the network (Step S31). After the request is received by the image capturing apparatus 20, the control unit 206 causes the storage unit 204 to temporarily store therein an image captured by the camera 22 and instructs the wireless communication unit 203 to transmit the image to the mobile terminal 10 as a preview image (Step S41). When the preview image transmitted from the wireless communication unit 203 is received by the wireless communication unit 103 of the mobile terminal 10, the control unit 106 causes the screen 13 to display the received preview image (Step S32). The loop process can be made to include a process of allowing the user to perform controls that are registered in the function list—such as pan, tilt and zoom—on the camera 22 of the image capturing apparatus 20 while seeing the preview image, so that the user is able to select a photo with a better composition.

When the shutter-button press operation of the user is received at the operation input unit 12 (S33: Yes), the control unit 106 takes out, from the function list, a URI requesting a shuttered image, http://192.168.0.1/Shutter, and instructs the wireless communication unit 103 to transmit a shuttered-image request to the image capturing apparatus 20 (Step S34). After the shuttered-image request is received by the image capturing apparatus 20, the control unit 206 causes the storage unit 204 to temporarily store therein an image captured by the camera 22 and instructs the wireless communication unit 203 to transmit the shuttered image to the mobile terminal 10 (Step S42). When the shuttered image transmitted from the wireless communication unit 203 is received by the wireless communication unit 103 of the mobile terminal 10, the control unit 106 causes the screen 13 to display the received shuttered image, and stores the image in the data accumulation unit 104 (Step S35).

After the transmission and reception of the shutter image is completed, on the image capturing apparatus 20 side, the control unit 206 controls the deletion unit 205 to delete all image data stored in the storage unit 204 (Step S43). Then, the wireless LAN session between the wireless communication units 103 and 203 ends according to the instructions of the control units 106 and 206. Thus concludes the detailed description of the procedure regarding the image capturing process.

Data encrypted with an encryption key included in the management information may be transmitted at the time of the image data transmission in Steps S41 and S42, and received data may be decrypted with the encryption key at the time of the data reception in the Steps S32 and S35. In this way, it is possible to provide a more secure communication method without imposing extra, special operations on the user, which leads to a significant reduction in risk of the communication being intercepted by ill-intentioned third parties.

In the communication establishment process, the communication establishment process completes with the transmission and reception of the function list after the exchange of the management information; however, in the case, when the transmission and reception of the function list is unnecessary, for example, the communication establishment process may complete with the transmission and reception of just minimum necessary management information for the establishment of the wireless LAN communication path between the wireless communication units 103 and 203.

Thus, according to the present embodiment, in the case when the contact detecting portion 11 of the mobile terminal 10 is brought in contact with the contact detecting portion 21 of the image capturing apparatus 20, the contact sensors 101 and 201 are able to detect the contact at the same time. Therefore, the present embodiment provides an advantageous effect that the transmission process of the apparatus on the transmitting side and the reception process of the apparatus on the receiving side can be set in precise synchronization with each other, thereby allowing for setting a very short period of time for transmission and reception of the management information.

By setting the transmitting and receiving operations of the management information to be completed in a significantly short period of time, a retry of the management information exchange is restricted when the exchange between the apparatuses is unsuccessful, and thus the time period for the transmission and reception of the management information will not be extended indiscriminatingly. In addition, in the case when the contact detecting portions 11 and 21 do not come in contact with each other—for example, in the case when a part of the mobile terminal 10 other than the contact detecting portion 11 comes in physical contact with the contact detecting portion 21 of the image capturing apparatus 20, the control unit 206 is informed of the contact; however, the control unit 106 is not informed of the contact since the contact sensor 101 cannot detect it. In such a case, although the short-range communication unit 102 of the mobile terminal 10 does not carry out the transmission and reception processes, the short-range communication unit 202 of the image capturing apparatus 20 carries out the process of transmitting its own management information and the process of receiving the management information of the mobile terminal 10. Here, however, it is only a short period of time during which the short-range communication unit 202 of the image capturing apparatus 20 transmits radio waves. This significantly reduces the possibility of miscommunicating with a different apparatus and the chances that the communication is intercepted by third parties and the like. Thus, even if the exchange of the management information between the apparatuses is unsuccessful, the present invention still maintains the convenience since a retry of the communication can be realized with the simple operation of bringing the apparatus in contact with each other, without requiring the user to perform cumbersome operations.

In addition, according to the present embodiment, the transmission and reception of the management information by the short-range communication units 102 and 202 are performed with the mobile terminal 10 and the image capturing apparatus 20 being in contact. Therefore, the present embodiment has an advantageous effect of allowing the power of the radio wave transmission to be the minimum necessary, besides the period of time for the radio wave transmission being significantly short. As a result, it is possible to realize more highly secured communication, preventing third parties from intercepting the communication.

Note that the present embodiment describes an example where, in the image capturing system 1, one mobile terminal 10 is connected to one image capturing apparatus 20 by wireless; however, the image capturing system 1 of the present invention can be realized by a structure in which multiple mobile terminals are connected to one image capturing apparatus 20 by wireless.

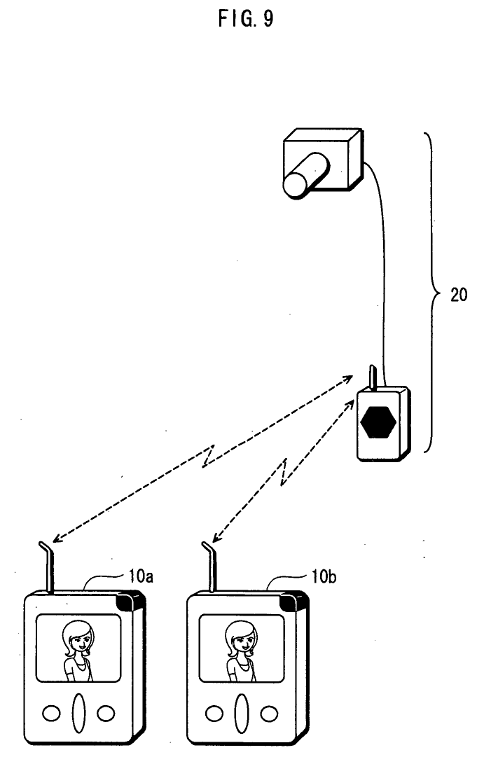

The operations of the image capturing system 1 including two mobile terminals are described next with the aid of FIG. 9. In FIG. 9, when two mobile terminals 10a and 10b are brought in contact with the image capturing apparatus 20 in order, wireless LAN communication is established between the image capturing apparatus 20 and the mobile terminal 10a as well as between the image capturing apparatus 20 and the mobile terminal 10b. The preview image is transmitted from the image capturing apparatus 20 to each of the two mobile terminals 10a and 10b, and the same preview image is displayed on their screens. Operations, such as a shutter operation, can be received at either of the mobile terminals 10a and 10b, and when the shutter button on one of the mobile terminals 10a and 10b is pressed, the shuttered image is transmitted from the image capturing apparatus 20 to both two mobile terminals 10a and 10b. Then, the same image is recorded in the data accumulation unit 104 of each mobile terminal.

These operations enable, when two users take commemorative photos together, the preview image can be simultaneously transmitted to the two mobile terminals each held by the individual users, and therefore the two users do not have to peer into a small screen on a single mobile terminal in order to decide the composition for a photo. Furthermore, with only a single shutter operation, the same image can be recorded in both users' mobile terminals effortlessly. This eliminates the needs of copying the captured image to a different terminal using a memory card or the like, or passing the captured image by attaching it to a mail, thus saving the users the trouble. These advantageous effects can also be realized when three or more users each having a mobile terminal take photos together. Especially, such effects become more pronounced with an increase in the number of the mobile terminals used at the same time.

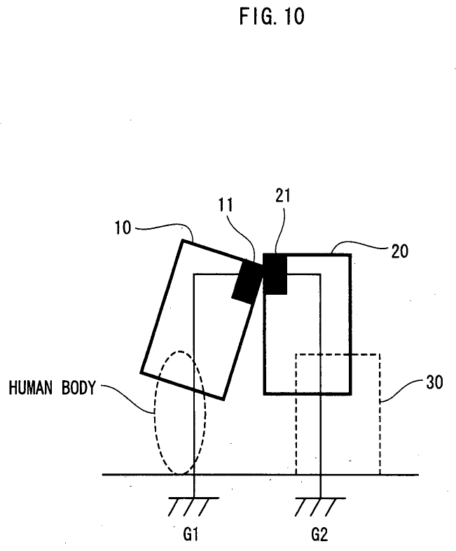

As a modification of the present embodiment, a structure may be adopted in which the contact sensors 101 and 201 are metal electrodes, and these two electrodes come in direct contact with each other. That is, the mobile terminal 10 having the contact sensor 101 is earthed to the ground at G1 via the body of the user, as shown in FIG. 10. On the other hand, the image capturing apparatus 20 having the contact sensor 201 is also earthed to the ground at G2 via the wall 30. Thus, the contact sensors 101 and 201 form an electric circuit via the human body, wall and grounds G1 and G2. It is possible to electrically detect the contact state between the contact sensors 101 and 201 by measuring the electric conduction of the electric circuit.

Furthermore, forming the contact sensors 101 and 201 with metal electrodes allows the terminals to communicate with each other via the metal electrodes being in contact with each other. If a structure that transmits and receives data via the contacting metal electrode is employed as the short-range communication units, management information, such as, terminal addresses required to establish wireless LAN communication, can be more safely exchanged between terminals.

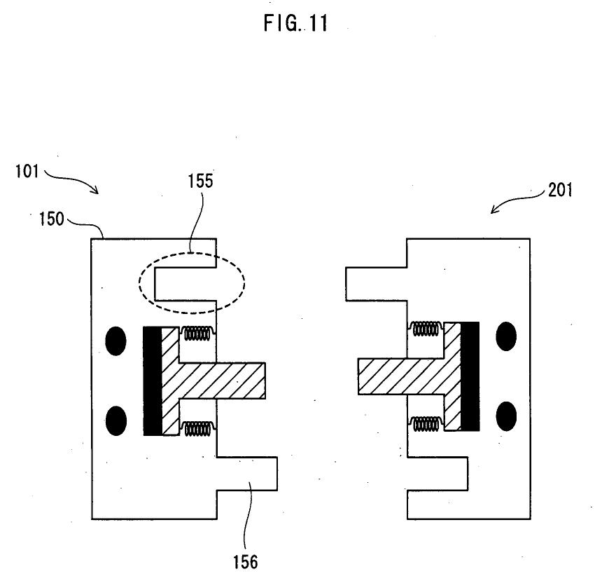

As another modification, a structure may be adopted in which a concave portion 155 and a convex portion 156 are provided with the case 150 of each of the contact sensors 101 and 201, as shown in FIG. 11. Here, only when the contact sensors 101 and 201 are brought in contact with each other in a manner that they oppose one another, the nonconductive element 152 is pushed in, and whereby the contact is detected. With such a structure, it is possible to prevent the management information from being transmitted when the contact sensor 101/201 makes contact with a part of the communication partner terminal other than the contact detecting portion. This leads to a further reduction in risk of the management information being intercepted by third parties.

### Embodiment 2

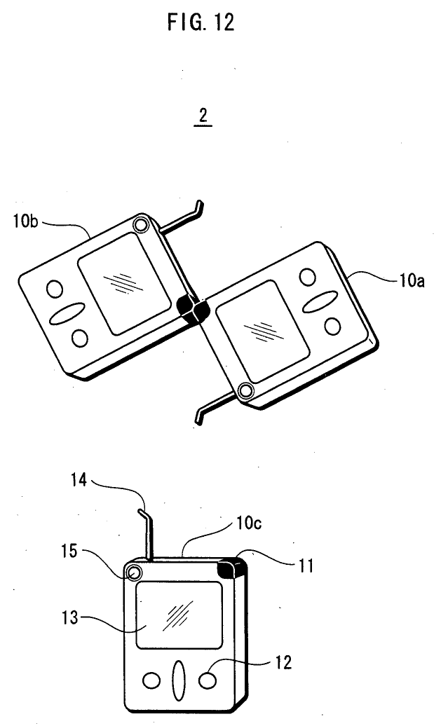

Embodiment 2 describes an image capturing system 2 that captures scenery of a tourist site, for example, using multiple mobile terminals having an image capturing function. Here, each of the mobile terminals is assigned to capture a part of the scenery. FIG. 12 shows the image capturing system 2 according to Embodiment 2. In FIG. 12, the wireless communication apparatuses pertaining to the present invention are mobile terminals 10a-10c, each of which has the same structure. The mobile terminals 10a-10c are PDAs having a wireless LAN communication function, and each is owned by a different user.

According to the present embodiment, by using the operation input unit 12, the user has set the mobile terminal 10a to function as a main terminal while having set the mobile terminals 10b and 10c to operate as slave terminals. Here, the main terminal is a mobile terminal functioning as the center of a wireless network having a star topology; the slave terminals are mobile terminals on the star network, except for the main terminal.

After the settings of main and slave terminals are thus made, the contact detecting portions of the mobile terminals 10a and 10b are brought in contact with each other, as shown in the figure. Then, the management information is exchanged between the mobile terminals 10a and 10b in the same manner as in Embodiment 1 to establish a wireless LAN communication path. Subsequently, when the contact detecting portions of the mobile terminals 10a and 10c are brought in contact with each other, a wireless LAN communication path is established between the mobile terminals 10a and 10c by exchanging the management information. As a result, a star network with the mobile terminal 10a in the center is formed, which functions as the entire image capturing system 2 of the present embodiment. After the formation of such a wireless network is made, data transmission and reception can be realized also between the mobile terminals 10b and 10c via the mobile terminal 10a.

After the wireless network is formed according to these operations, when an image is captured by one of the mobile terminals 10a-10c, the image data is transmitted to the other terminals via the wireless LAN and then recorded in all the mobile terminals 10a-10c.

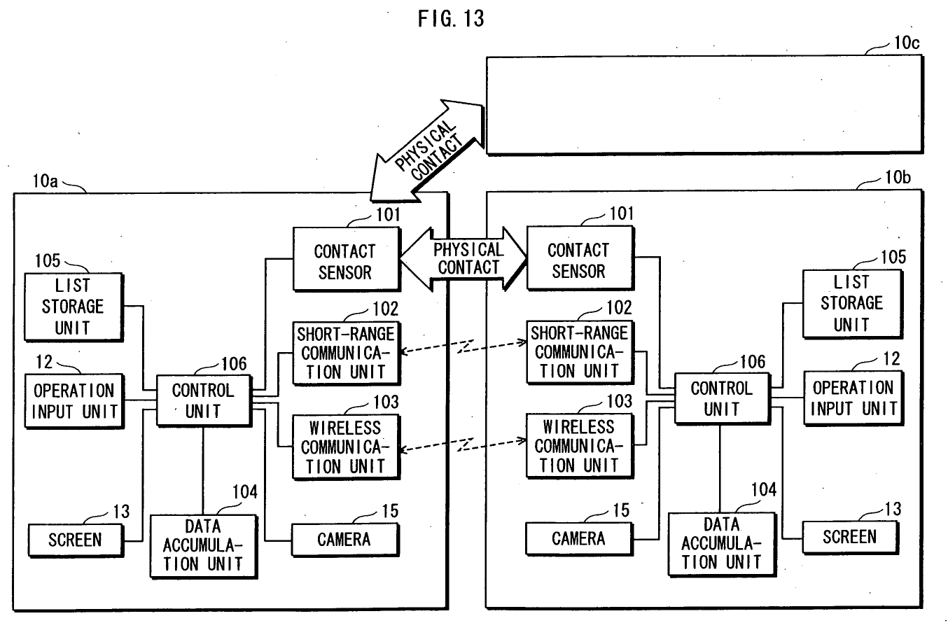

FIG. 13 shows the internal structures of apparatuses constituting the image capturing system 2 of Embodiment 2. Note that the mobile terminal 10c has the same internal structure as the mobile terminals 10a and 10b. The following describes the internal structures of these mobile terminals using the mobile terminal 10a as an example.

The mobile terminal 10a has a structure that includes therein a camera 15 in addition to the components of the mobile terminal 10 of Embodiment 1. The components identical to those in the mobile terminal 10 of FIG. 1 are given the same reference numerals, and the explanations for these components are omitted.

The camera 15 is a digital camera using a CCD or a CMOS sensor.

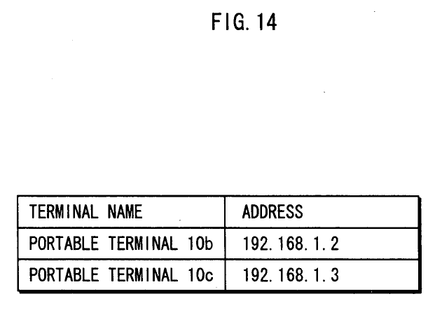

The list storage unit 105 is used to store a terminal list for identifying terminals for which wireless LAN communication has been established, in addition to a function list showing services that can be offered by the mobile terminals 10b and 10c. FIG. 14 shows a terminal list stored in the list storage unit 105 of the mobile terminal 10a after the network is established. The terminal list includes the same number of records as the number of terminals for which communication has been established, and each record is composed of two fields, a terminal name and an address.

In the function list, services for sending, in response to requests, image data captured by the camera 15 and their corresponding URIs are registered.

Thus has been described the internal structure of the mobile terminal 10a of Embodiment 2. With the mobile terminals 10a-10c having such s structure, when the contact detecting portion 11 of the mobile terminal 10a comes in physical contact with the contact detecting portion 11 of the mobile terminal 10b as shown in FIG. 12, the contact is detected by both mobile terminals 10a and 10b substantially at the same time. In response to the detection, the respective short-range communication units 102 perform transmission and reception of the management information. Accordingly, even if the mobile terminal 10c is in proximity, interference among the three mobile terminals 10a-10c can be avoided and the exchange of the management information is successfully conducted between the mobile terminals 10a and 10b.

As a method of identifying, among two or more terminals, one terminal with which data communication is to be made, UPnP (Universal Plug and Play) can be applied, and the terminals may exchange their management information including a UUID.

The following explains operations of the image capturing system 2 according to Embodiment 2. In the following explanation, assume that the user has set the mobile terminal 10a to function as a main terminal while having set the mobile terminals 10b and 10c to operate as slave terminals.

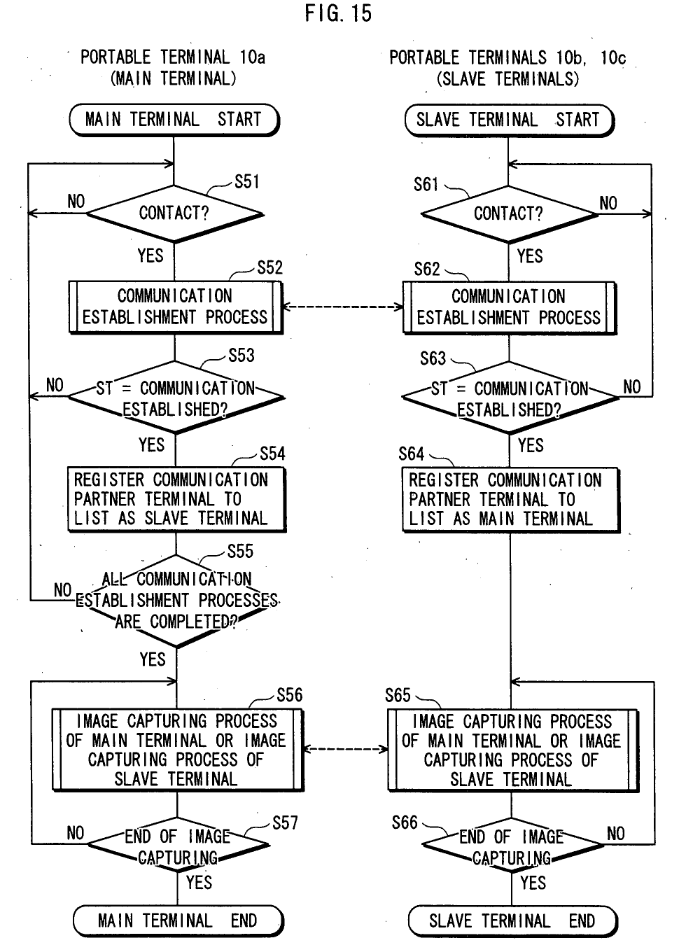

FIG. 15 is a flow showing operations of the image capturing system 2. Respective steps of the procedure shown in the figure are controlled by the control unit 106.

In each mobile terminal, the control unit 106 monitors whether another mobile terminal comes in contact with the contact detecting portion 11 (S51 and S61). When the users bring the mobile terminals in hand in contact with each other, the communication establishment process is carried out between the mobile terminals whose contact sensors 101 have detected the contact (S52 and S62).

If the establishment of the communication path is failed as a result of the communication establishment process (Step S53: No, Step S63: No), the control units 106 go back to Steps S41 and S51, respectively, and wait for a next contact detection.

If the establishment of the communication path is successful as a result of the communication establishment process (Step S53: Yes, Step S63: Yes), the control units 106 of the main terminal registers the address of the communication partner terminal to the terminal list as a slave terminal, and stores the terminal list in the list storage unit 105 (Step S54). On the slave terminal side, the control unit 106 registers the address of its communication partner terminal to the terminal list as the main terminal, and stores the terminal list in the list storage unit 105 (Step S64). Subsequently, on the main terminal side, the control unit 106 repeats Steps S51-S55 until the communication establishment process with all the slave terminals are completed (Step S55: Yes).

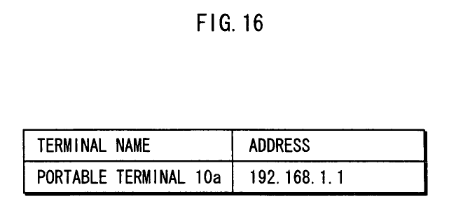

According to the present embodiment, the mobile terminal 10a goes through twice the process of Steps S51-S55 when it is brought in contact with the mobile terminal 10b and with the mobile terminal 10c, both of which are to function as slave terminals. The mobile terminals 10b and 10c respectively go through the process of Steps S61-S64 once when they are brought in contact with the mobile terminal 10a, which is to function as a main terminal. As a result, the terminal list shown in FIG. 14 is stored in the list storage unit 105 of the main terminal, i.e. the mobile terminal 10a; the terminal list shown in FIG. 16 is stored in the list storage units 105 of the slave terminals, i.e. the mobile terminals 10b and 10c.

After a wireless network is established among the mobile terminals 10a-10c according to the above procedure, every time when individual users each having the mobile terminals 10a-10c, respectively, press on the shutter button on their mobile terminals, each mobile terminal performs the image capturing process (Step S56, Step S65). When completion of image capturing is instructed according to a user's operation (Step S57: Yes, Step S66: Yes), each of the mobile terminals 10a-10c ends the operation. Thus concludes the description of the operations performed by the image capturing system 2.

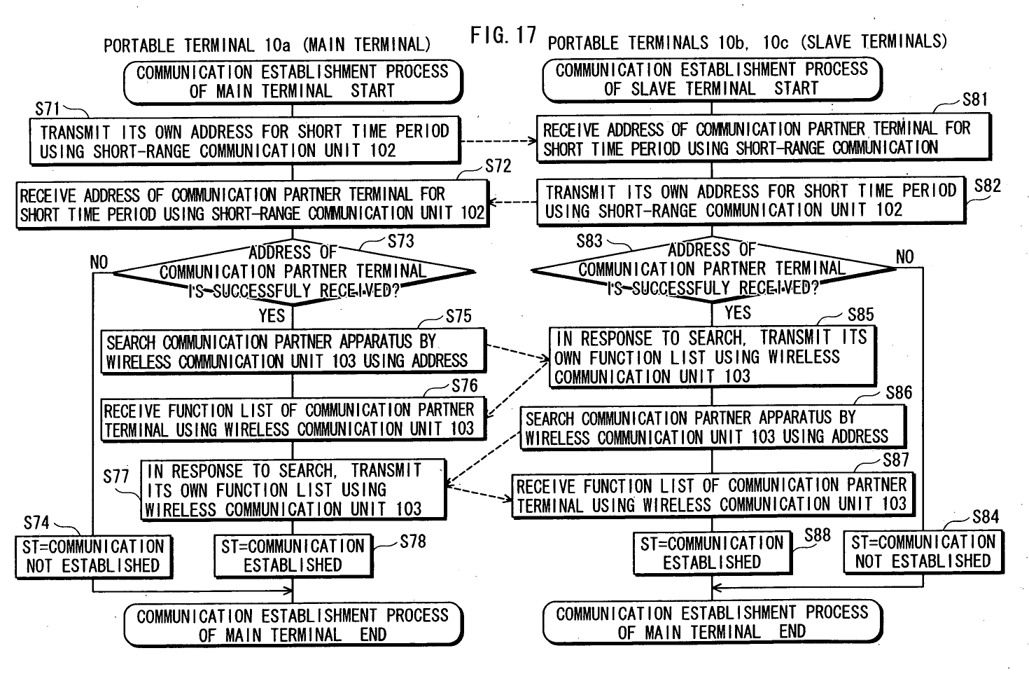

Next, as to the communication establishment process carried out in Steps S52 and S62 of FIG. 15, the procedure is detailed with reference to a flowchart. FIG. 17 is a flowchart showing the procedure of the communication establishment process according to Embodiment 2.

When contact is detected, on the main terminal side, the control unit 106 instructs the short-range communication unit 102 to transmit its own management information (Step S71). On the slave terminal side, on the other hand, the control unit 106 instructs the short-range communication unit 102 to carry out the reception operation (Step S81).

Subsequently, the control unit 106 of the main terminal instructs the short-range communication unit 102 to perform the reception operation (Step S72); while the control unit 106 of the slave terminal instructs the short-range communication unit 102 to transmit its own management information (Step S82).

Here, all the transmission operations of Steps S71 and S82 and the reception operations of Steps S81 and S72 performed by the main terminal and slave terminals are each carried out for only a predetermined period of time. As a result, as to the main and slave terminals that have started the process in response to contact with each other, the transmission operation of the main terminal (Step S71) and the reception operation of the slave terminals (Step S81) are performed in precise synchronization with each other, as well as the reception operation of the main terminal (Step S72) and the transmission operation of the slave terminals (Step S82) are performed in precise synchronization with each other. Accordingly, the durations of these transmission and reception operations can be made extremely short.

According to the above-mentioned process, the main and slave terminals have completed the exchange of each other's addresses used to identify their own communication partner terminals on the network. The control units 106 of the main and slave terminals manage success and failure of the communication establishment processes using a variable ST. When receiving the address of a communication partner terminal is failed due to poor wireless reception or the like (Step S73: No, Step S83: No), the control units 106 store a status of “communication not established” in the variable ST and ends the communication establishment process (Step S74, Step S84).

In the subsequent processes after each other's addresses have been exchanged, the communication between the slave terminals and the mobile terminal 10a being the main terminal is wireless LAN communication using the wireless communication units 103 and 203.

After the address of a communication partner terminal is normally and successfully received (Step S73: Yes, Step S83: Yes), on the main terminal side, the control unit 106 causes the wireless communication unit 103 to search a slave terminal corresponding to the received address (Step S75). In response to the search, on the slave terminal side, an instruction is made to the wireless communication unit 103 to transmit, to the received main terminal's address, a function list that can be provided (Step S85). The function list is received at the wireless communication unit 103 of the main terminal and stored in the list storage unit 105 (Step S76).

Then, on the slave terminal side, the control unit 106 causes the wireless communication unit 103 to search the main terminal corresponding to the received address (Step S86). In response to the search, on the main terminal side, an instruction is made to the wireless communication unit 103 to transmit, to the received slave terminal's address, a function list that can be provided (Step S77). The function list is received at the wireless communication unit 103 of the slave terminal and stored in the list storage unit 105 (Step S87).

When acquisition of each other's function lists is successful according to the above procedure, the main and slave terminals respectively store a status of “communication established” in the variable ST held by their control units 106, and ends the communication establishment process (Step S78, Step S88).

Thus concludes the detailed description of the communication establishment process. According to the procedure, a secure wireless communication path is established between the main and slave terminals, which enables bi-directional transmission and reception of control data and image data.

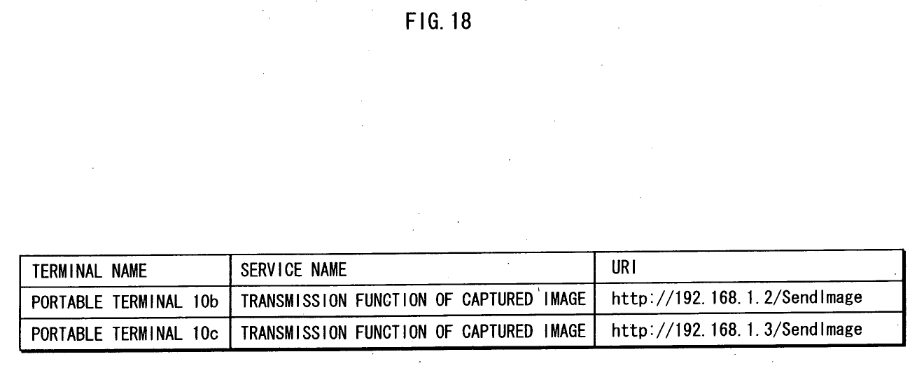

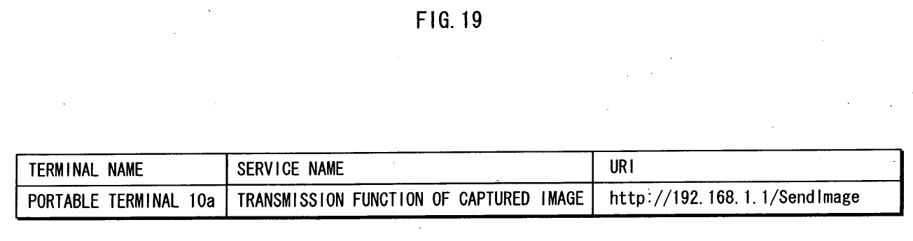

With such a communication establishment process being carried out between the mobile terminals 10a and 10b, and between the mobile terminals 10a and 10c, a function list shown in FIG. 18 is stored in the list storage unit 105 of the mobile terminal 10a and a function list shown in FIG. 19 is stored in the list storage units 105 of both mobile terminals 10b and 10c.

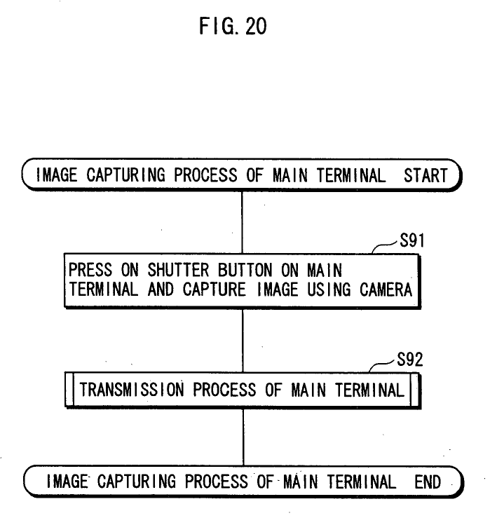

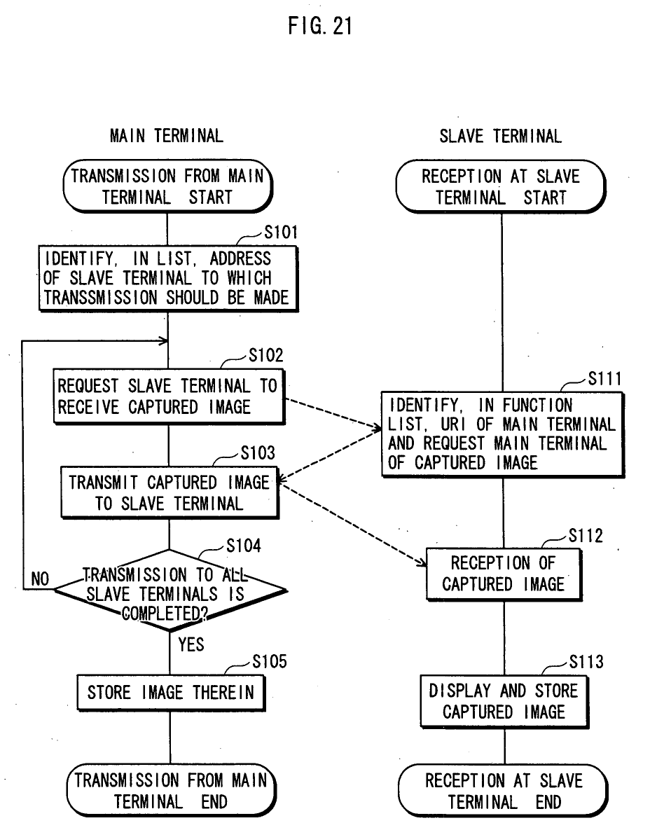

The following describes details of the procedure of the image capturing process carried out in Steps S56 and S65 of FIG. 15. The procedure of the image capturing process of the present embodiment differs according to whether a terminal that takes an image is the main terminal or a slave terminal. First, the image capturing process performed when the main terminal carries out the image capturing operation is explained with reference to FIGS. 20 and 21.

As shown in FIG. 20, when the operation input unit 12 of the main terminal receives a shutter-button press operation, the camera 15 captures an image at the moment, and the control unit 106 of the main terminal temporarily stores the image data in an operation area of the RAM (Step S91). Subsequently, a transmission process is carried out in which the main terminal transmits the image data sequentially to all the slave terminals, and then have the image data recorded therein (Step S92).

In the transmission process as FIG. 21 shows the details, the control unit 106 of the main terminal reads, from the terminal list stored in the list storage unit 105, addresses of all the slave terminals to which the captured image is to be transmitted (Step S101), and performs the process of Steps S102-S104 on the individual slave terminals corresponding to the read addresses.

Specifically speaking, first, the control unit 106 of the main terminal requests a first slave terminal to receive a captured image transmitted from the main terminal (Step S102). The control unit 106 of the slave terminal which has received the request takes out, from the function list, a URI for requesting a captured image, http://192.168.1.1/GetImage, identifies the URI, and posts a request to the main terminal (Step S111). Then, the control unit 106 of the main terminal transmits the image data temporarily stored in the operation area of the RAM to the slave terminal (Step S103).

On the slave terminal side, the wireless communication unit 103 receives the image data (Step S112), and the control unit 106 causes the screen 13 to display an image based on the received image data, and stores the received image data in the data accumulation unit 104 (Step S113).

After transmitting the temporarily stored image data to all the slave terminals that are registered on the terminal list (Step S104: Yes), the control unit 106 of the main terminal stores, in its own data accumulation unit 104, the image data temporarily stored in the operation area of the RAM (Step S105). Thus concludes the detailed description of the image capturing process performed when the main terminal is the image capturing apparatus.

The following explains the image capturing process performed when the capturing operation is made on a slave terminal. The image capturing process performed when an image is captured by a slave terminal differs from that performed when an image is captured by the main terminal in that a process of transmitting the image captured by the slave terminal once to the main terminal is added. The image data transmitted to the main terminal is then transmitted to all the slave terminals according to the same procedure taken when the capturing operation is made on the main terminal.

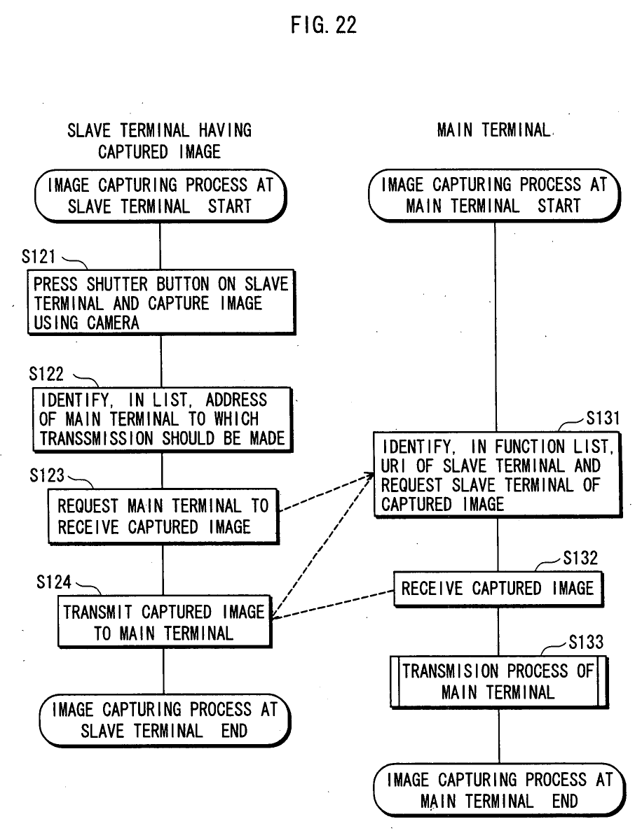

Next, the image capturing process performed when an image is captured by a slave terminal is detailed using FIG. 22, along with an example of the image capturing process performed on the mobile terminal 10b (a slave terminal).

When the operation input unit 12 of the mobile terminal 10b receives a shutter-button press operation, the camera 15 captures an image at the moment, and the control unit 106 of the mobile terminal 10b temporarily stores the image data in an operation area of the RAM (Step S121). Subsequently, the control unit 106 of the mobile terminal 10b reads, from the terminal list stored in the list storage unit 105, an address of the main terminal to which the image data is to be transmitted (Step S122), and transmits a request to the main terminal so as to receive the image data stored in the mobile terminal 10b (Step S123). In response to the request, the control unit 106 of the main terminal takes out, from the function list, a URI for requesting the mobile terminal 10b to transmit a captured image, http://192.168.1.2/GetImage, identifies the URI, and post a request to the mobile terminal 10b (Step S131). Then, the control unit 106 of the mobile terminal 10b transmits the image data temporarily stored in the operation area of the RAM to the main terminal (Step S124). The control unit 106 of the main terminal stores the received image data in an operation area of the RAM (Step S132), and transmits the image data to all the slave terminals sequentially, according to the transmission process shown in FIG. 21 (Step S133). Thus concludes the detailed description of the image capturing process performed when a slave terminal is the image capturing apparatus.

According to the present embodiment, it is possible to establish a wireless network in a simple, reliable and secure manner by bringing mobile terminals held by the users in contact with each other. After the wireless network is established, an image captured by any mobile terminal is immediately distributed and then stored in the rest of the mobile terminals on the wireless network. Thus, the present embodiment eliminates the needs of exchanging and sorting image data among the mobile terminals using detachable memory cards and/or mails after an image is captured. This provides an advantageous effect that, especially when two or more people in a tour group or the like together have a common intention of taking sightseeing photos, the group's cooperative operation can be achieved readily, efficiently, and also in a reliable manner.

### Embodiment 3

Embodiments 1 and 2 have described the structures that use physical contact between terminals as a trigger of the communication establishment. Embodiment 3 describes an information processing system 3 that uses physical contact between terminals as a command for starting image transfer between the terminals.

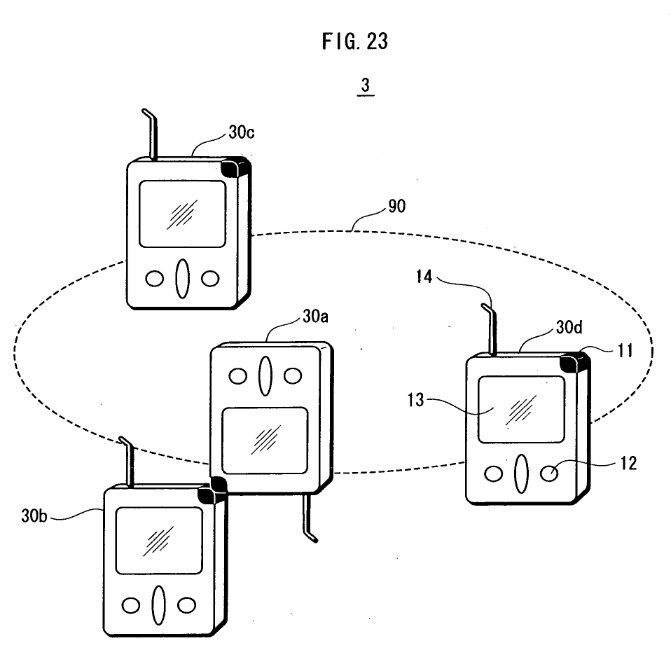

FIG. 23 shows the information processing system 3 according to Embodiment 3. In FIG. 23, the wireless communication apparatuses pertaining to the present invention are mobile terminals 30a-30d each having a wireless LAN communication function. These mobile terminals 30a-30d connect to each other via a wireless network 90 to thereby form the information processing system 3. In the following explanation, assume that the mobile terminals 30a-30d are connected to the wireless network 90 and connection between each terminal has been established.

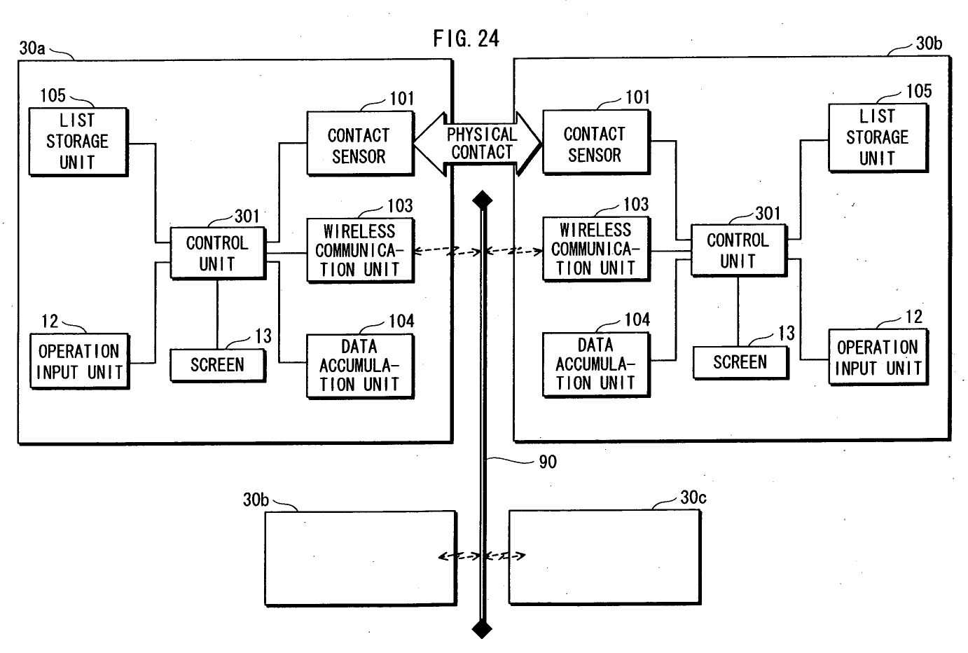

FIG. 24 shows internal structures of apparatuses constituting the information processing system 3 according to Embodiment 3. The mobile terminals 30c and 30d have the same internal structures as the mobile terminals 30a and 30b.

Each of the mobile terminals 30a-30d has a structure as if it were formed by removing the short-range communication unit 102 from the mobile terminal 10a shown in FIG. 3 and replacing the control unit 106 with a control unit 301. The components identical to those in the mobile terminal 10 of FIG. 1 are given the same reference numerals, and the explanations for these components are omitted.

The control unit 301 is a typical computer system including a CPU, and a ROM storing therein programs and a RAM. The control unit 301 causes a program stored in the ROM to be read to the CPU, and then makes the program and hardware resources operate in cooperation, whereby realizing controls of an image transfer process. The image transfer process performed by the control unit 301 is a process in which image data stored in the data accumulation unit 104 of a terminal is transmitted to a different terminal with which the terminal has been brought in contact in response to a contact detection by the contact sensor 101.

Thus concludes the description of the internal structures of the mobile terminals 30a-30d according to Embodiment 3.

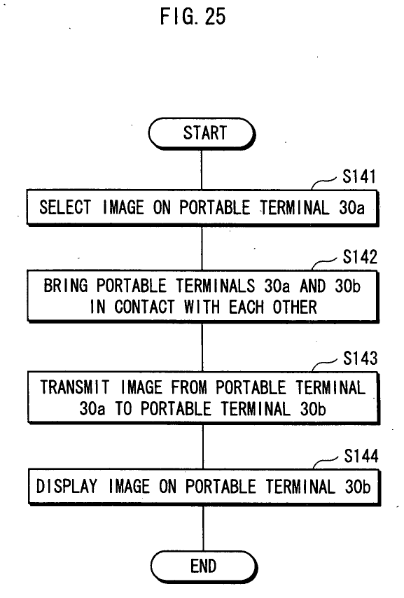

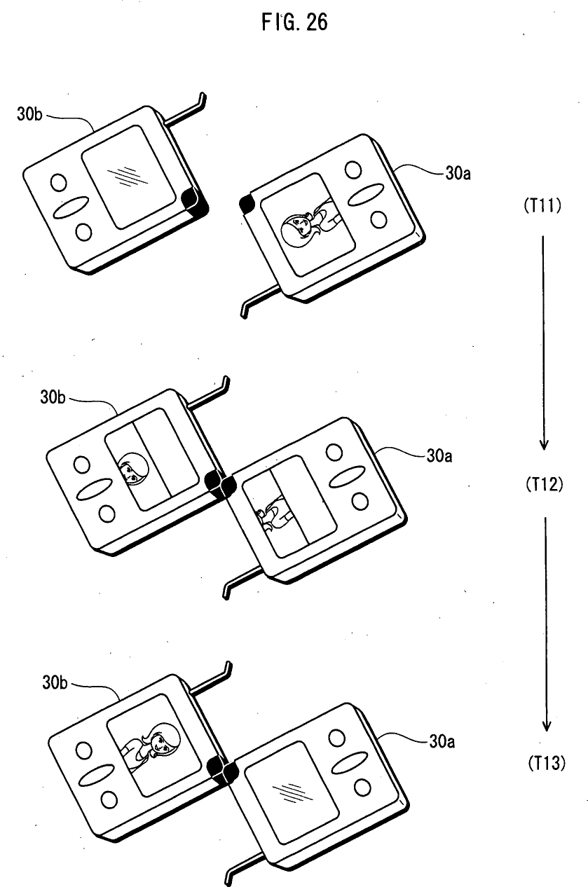

The following explains the image transfer process. FIG. 25 is a flow showing operations of the image transfer process according to Embodiment 3; FIG. 26 schematically shows operational states of the image transfer process. Here, the image transfer process is outlined with an example where an image already accumulated in the mobile terminal 30a is copied and transferred to the mobile terminal 30b.

First, the user carrying the mobile terminal 30a selects image data desired to be transferred to the mobile terminal 30b, and then the image is displayed on the screen 13, shown as T11 (Step S141). In this state of things, the contact detecting portions of the mobile terminals 30a and 30b are brought in contact with each other (Step S142), and then the image data selected in Step S141 is transmitted from the mobile terminal 30a to the mobile terminal 30b via the wireless network 90 (Step S143).

During the transmission process, displays on the screens 13 of the mobile terminals 30a and 30b are controlled in a manner shown as T12, according to the stage of progression. Specifically speaking, on the screen 13 of the mobile terminal 30a, the displayed image selected in Step S141 gradually moves toward the upper side of the screen 13 and disappears from the screen 13; in parallel, the same image selected in Step S141 gradually appears on the screen 13 of the mobile terminal 30b from the lower side.

Eventually, as shown in T13, when the transmission process is completed, the displayed image completely disappears from the screen 13 of the mobile terminal 30a; the desired image is recorded in the mobile terminal 30b and the complete image is displayed on the screen 13 of the mobile terminal 30b (Step S144). Thus, the screen change linked to the stage of process progression facilitates the users to easily see the progression and completion of the transmission process.

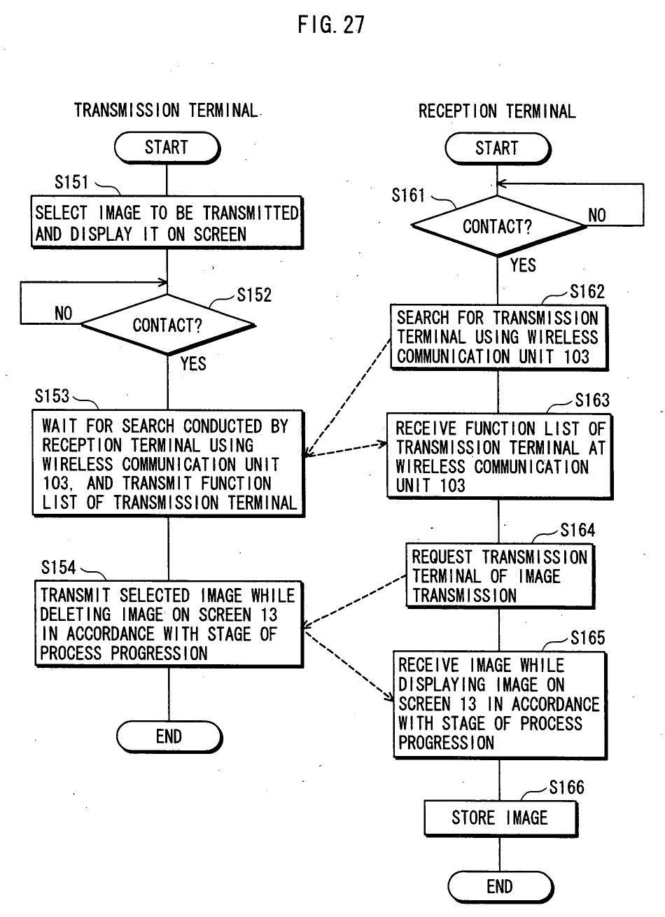

The following describes details of controls on the image transfer process performed by the control unit 301. FIG. 27 is a flowchart showing a control procedure of the image transfer process performed by the control unit 301.

Assume that the mobile terminals 30a-30d have been connected to the wireless network 90 by their wireless communication units 103 and communication paths among these terminals have been established. Here, it is possible to perform transmission and reception of image data and control data between any terminal and a different terminal by identifying addresses of those terminals. The following explains processing steps between two terminals, referring to a mobile terminal being a transmission source of image data as a transmission terminal while referring to a mobile terminal that receives the image data as a reception terminal.

On the transmission terminal side, when the operation input unit 12 receives a user operation of selecting desired image data from image data stored in the data accumulation unit 104, the control unit 301 displays the image of the selected image data on the screen 13 (Step S151).

In this state of things, the control units 301 of both terminals monitor whether there is a contact detection at their contact sensors 101 in the loop processes of Steps S152 and S161, respectively. Accordingly, when the users bring the contact detecting portions 11 in contact with each other, the control units 301 of the transmission and reception terminals move to their next steps in synchronization.

The control unit 301 of the reception terminal that has been informed of a contact detection by its own contact sensor 101 searches for a transmission terminal in a stand-by mode from among all the mobile terminals connected to the wireless network 90 (Step S162). On the other hand, the control unit 301 of the transmission terminal that has been informed of a contact detection by its own contact sensor 101 waits for the search. Then, when receiving the search from the reception terminal at the wireless communication unit 103, the control unit 301 of the transmission terminal transmits its own function list to the reception terminal (S153).

When receiving the function list of the transmission terminal at the wireless communication unit 103, the control unit 301 of the reception terminal stores the function list in the list storage unit 105 (Step S163).

Here, if the mobile terminal 30a is the transmission terminal while the mobile terminal 30b is the reception terminal, and the contact sensors of the remaining mobile terminals 30c and 30d have not detected contact, the mobile terminals 30c and 30d are not waiting for the search. Therefore, although the mobile terminals 30c and 30d are connected to the wireless network 90, they do not erroneously respond to the search transmitted from the reception terminal in Step S162.

In addition, between the transmission terminal and the reception terminal, the start of the search operation and the start of the search-waiting operation are set in very precise synchronization with each other since contact between these terminals is used as the trigger. Accordingly, the present embodiment can make the execution time of the search in Step S162 short. Therefore, even if the mobile terminals 30c and 30d are brought in contact with each other at the substantially same time when the mobile terminals 30a and 30b are brought in contact, it is possible to significantly reduce the chances that the mobile terminals 30c and 30d erroneously respond to the search operation conducted between the mobile terminals 30a and 30b by making the execution time of the search in Step S162 short, and now therefore, it is considered there is no problem in the practical use.

After obtaining the function list in Step S163, the control unit 301 of the reception terminal takes out a URI of the transmission terminal with reference to the function list, and requests the transmission terminal to transmit the image data (Step S164).

When the transmission terminal receives the request for transmitting the image data, the control unit 301 of the transmission terminal starts transmitting the image data selected by the user in Step S151 to the reception terminal while successively calculating the progression rate of the transmission process and continuously changing the display of the image on the screen 13 (Step S154). The control unit 301 of the reception terminal receives the image data while successively calculating the progression rate (0-100%) of the reception process and continuously changing the display of the image on the screen 13 (Step S165). Subsequently, when the reception of the image data is completed, the control unit 301 of the reception terminal stores the image data in the data accumulation unit 104 (Step S166).

The following describes a specific example of display control executed in Steps S154 and S165. Here, assume that the image data is JPEG image data, and that the reception terminal is able to display a partial image when part of the image data is obtained.

On the transmission terminal side, the ratio of the amount of the image data that has been transmitted to the entire amount of the image data is calculated as the progression rate. When the progression rate is 0%, the entire image is displayed on the screen 13. As the progression rate increases, the upper side of the image displayed on the screen 13 is gradually deleted while the displayed image is shifted toward the upper side of the screen 13 as if the image smoothly scrolls out of the screen 13. Here, a control is made so that the ratio of the deleted part of the image to the area of the entire image becomes the same as the progression rate. As a result, when the progression rate reaches 100% in due time, the selected image has entirely disappeared from the screen 13 of the transmission terminal.

On the reception terminal side, on the other hand, the ratio of the amount of the image data that has been received to the entire amount of the image data is calculated as a progression rate. When the progression rate is 0%, no image is displayed on the screen 13. As the progression rate increases, part of the image that has been received is displayed on the lower side of the screen 13. Here, the displayed image is shifted toward the upper side of the screen 13 in accordance with an increase in the progression rate so that the image is displayed as if it smoothly scrolls in from the outside of the screen 13. As a result, when the progression rate reaches 100% in due time, the entire image is displayed on the screen 13 of the reception terminal. For example, T12 shown in FIG. 26 illustrates a state where the progression rate is 50%, and 50% of the image is displayed respectively on the transmission terminal and the reception terminal. Thus conclude the details of controls on the image transfer process performed by the control units 301.

According to the present embodiment, it is possible to transmit and receive images and other data recorded on mobile terminals by simple operations of gathering in with the mobile terminals and bringing them in contact with each other.

The present embodiment describes the case in which the mobile terminals are connected to the wireless network 90 and the communication between each terminal has been established, and in this state of things, contact between the mobile terminals is used as a trigger of the image transfer process. However, the communication establishment process and the image transfer process may be uninterruptedly performed by selecting an image desired to be transmitted to the other terminal and bringing the mobile terminals in contact with each other, as in the case of Embodiment 2. This allows users who met for the first time to readily pass images by using their mobile terminals without special operations of setting a password and/or identifying an address of the other user's mobile terminal.

<Other Modifications>

The present invention has been described based on the above embodiments; it is a matter of course, however, the present invention is not limited to these embodiments. The following cases are also within the scope of the present invention.

(1) The present invention may be a method showing a procedure using the individual flowcharts above. In addition, it may be a computer program for executing the method using a computer, and may be a digital signal made up of the computer program.

Also, the present invention may be a computer readable recording medium—such as a flexible disk, a hard disk, a CD-ROM, a MO, a DVD, a DVD-ROM, a DVD-RAM, or a BD (Blu-ray Disc)—or a semiconductor memory on which the computer program or the digital signal is recorded. Furthermore, the present invention may be the computer program or the digital signal which is recorded on any of these recording media.

The present invention may be transmission of the computer program or the digital signal via an electric communication line, wireless or wire communication line, or a network represented by the Internet.

The present invention may be a computer system including a microprocessor and a memory, in which the computer program is recorded in the memory. Here, the microprocessor operates in accordance with the computer program.

The program or the digital signal may be implemented by a stand-alone computer system by recording it on any of the above-mentioned recording media and transferring the recording medium, or by transferring it via the network or the like.

(2) In Embodiment 1, the image capturing apparatus 20 has the structure made up of discrete operational units of the operation unit 20a and the camera unit 20b. This structure has been designed with the intention of allowing images to be captured from a high point while the contact detecting unit is installed at a place the user can reach. Therefore, in the case when the camera is installed at a relatively low point, for example, a structure may be employed in which the camera 22 and the contact sensor 201 are set in a single case together.

(3) Embodiments 1 to 3 describe the case in which a wireless LAN is used for the wireless communication; however, the present invention can be applicable to the case that uses, as the wireless communication, any one of publicly known short-range wireless communication systems—such as a wireless LAN in compliance with IEEE802.11a/b/g/n, Bluetooth, IrDA, Zigbee, and UWB—and publicly known mobile network—such as WCDMA, CDMA2000, PDC, and PHS.

(4) The security level of the communication can be further improved if the management information transmitted by the short-range communication unit is limited to the minimum necessary—for example, information and encryption key data only, which are required to establish a communication session.

(5) An existing piezoelectric sensor can be used as the detection unit. The piezoelectric sensor detects pressure generated when the mobile terminals are brought in contact with each other as a voltage change of the piezoelectric sensor, and in this way the pressure of the contact can be electrically detected.

Alternatively, the detection unit can be realized with a touch panel integrated with a screen. Touch panels are widespread devices to which inputs are made by click and drag operations by touch of a finger or a stylus pen. The use of a terminal including a touch panel realizes a detection of contact inexpensively without adding a new device for a contact detection.

Furthermore, as a different method, the detection unit can be realized using a vibration sensor and a microphone. With such a structure, contact can be detected by vibration and sound generated at the contact.

(6) The present invention may be any combination of the above Embodiments and modifications.

### INDUSTRIAL APPLICABILITY

The present invention is applicable to, for example, a digital camera and a PDA that have a wireless communication function.

1. A wireless communication apparatus for performing wireless communication with another communication apparatus, comprising:
a detection unit operable to detect physical contact with the another communication apparatus;
a transmission unit operable to transmit 1^{st} management information required for a session of the wireless communication to the another communication apparatus, using a short-range communication method different from a method of the wireless communication; and
a communication control unit operable to cause the transmission unit to transmit, in response to a detection of the physical contact, the 1^{st} management information for a predetermined period of time, and start the session with the another communication apparatus after the predetermined period of time has elapsed.

2. The wireless communication apparatus of claim 1, further comprising:
a reception unit operable to, using the short-range communication method, receive 2^{nd} management information transmitted by the another communication apparatus, wherein
the communication control unit causes the reception unit to receive, in response to the detection of the physical contact, the 2^{nd} management information for one of the predetermined period of time and a predetermined reception period longer than the predetermined period of time, and performs the session based on the received 2^{nd} management information.

3. The wireless communication apparatus of claim 2, wherein
the short-range communication method used by the transmission unit to transmit the 1^{st} management information uses a radio wave whose transmit power is smaller than a transmit power of a radio wave used for the wireless communication.

4. The wireless communication apparatus of claim 2, wherein
the short-range communication method is a communication method for transmitting and receiving a signal to and from the another communication apparatus through a signal path via a point of the physical contact.

5. The wireless communication apparatus of claim 1, wherein
the 1^{st} management information includes an apparatus address of the wireless communication apparatus, the apparatus address being used in the wireless communication.

6. The wireless communication apparatus of claim 1, wherein
the 1^{st} management information includes an authentication key used in authentication of the wireless communication apparatus, and
the communication control unit authenticates communication with the another communication apparatus using the authentication key when starting the session.

7. The wireless communication apparatus of claim 1, wherein
the 1^{st} management information includes an encryption key, and
the communication control unit, using the encryption key, encrypts data to be transmitted in the wireless communication and decrypts data received in the wireless communication.

8. The wireless communication apparatus of claim 1, wherein
the detection unit detects the physical contact in a case where a contact detecting portion of the another communication apparatus comes in contact with a contact detecting portion of the wireless communication apparatus.

9. An integrated circuit of a wireless communication apparatus that performs wireless communication with another communication apparatus, comprising:
a detection receiving unit operable to receive a detection signal indicating a detection of physical contact between the wireless communication apparatus and the another communication apparatus;
a transmission unit operable to transmit management information required for a session of the wireless communication to the another communication apparatus, using a short-range communication method different from a method of the wireless communication; and
a communication control unit operable to cause the transmission unit to transmit, in response to reception of the detection signal by the detection receiving unit, the management information for a predetermined period of time, and start the session with the another communication apparatus after the predetermined period of time has elapsed.

10. A communication control method used by a wireless communication apparatus that performs wireless communication with another communication apparatus, comprising:
a detection step of detecting physical contact between the wireless communication apparatus and the another communication apparatus;
a transmission step of transmitting, in response to a detection of the physical contact, management information required for a session of the wireless communication to the another communication apparatus for a predetermined period of time using a short-range communication method different from a method of the wireless communication; and
a start step of starting the session with the another communication apparatus after the predetermined period of time has elapsed.

11. A computer program used for controlling a wireless communication apparatus that performs wireless communication with another communication apparatus, the computer program causing the wireless communication apparatus to execute:
a detection step of detecting physical contact between the wireless communication apparatus and the another communication apparatus;
a transmission step of transmitting, in response to a detection of the physical contact, management information required for a session of the wireless communication to the another communication apparatus for a predetermined period of time, using a short-range communication method different from a method of the wireless communication; and
a start step of starting the session with the another communication apparatus after the management information is transmitted predetermined period of time has elapsed.
